(19) United States
(12) Patent Application Publication
(10) Pub. No.: US 2026/0288774 A1
(43) Pub. Date: Sep. 24, 2026

(54) INFORMATION PROCESSING SYSTEM, INFORMATION PROCESSING METHOD, AND NON-TRANSITORY RECORDING MEDIUM

(71) Applicant: Toshiharu Nakashima, KANAGAWA (JP)

(72) Inventor: Toshiharu Nakashima, KANAGAWA (JP)

(73) Assignee: Ricoh Company, Ltd., Tokyo (JP)

(21) Appl. No.: 19/562,077

(22) Filed: Mar. 10, 2026

(30) Foreign Application Priority Data
Mar. 18, 2025 (JP) 2025-043563
Nov. 27, 2025 (JP) 2025-206864

(51) Int. Cl. G06F 16/332; G06F 16/334; G06F 16/338

(52) U.S. Cl. CPC G06F 16/3325; G06F 16/3347; G06F 16/338

(57) ABSTRACT

An information processing system includes a memory that stores terms and corresponding texts in association with each other, the corresponding texts each corresponding to a respective one of the terms, and circuitry that receives input of an input text, identifies a term associated with a corresponding text that is similar to the input text among the corresponding texts, based on similarities between the input text and the corresponding texts, searches for electronic data, based on the identified term, and outputs a response based on the electronic data retrieved in the search.

### CROSS-REFERENCE TO RELATED APPLICATIONS

This patent application is based on and claims priority pursuant to 35 U.S.C. § 119 (a) to Japanese Patent Application Nos. 2025-043563, filed on Mar. 18, 2025, and 2025-206864, filed on Nov. 27, 2025, in the Japan Patent Office, the entire disclosure of which is hereby incorporated by reference herein.

### BACKGROUND

### Technical Field

The present disclosure relates to an information processing system, an information processing method, and a non-transitory recording medium.

### Related Art

Expressions such as technical terms, abbreviations, and paraphrased expressions often hinder an electronic data search. The presence of such expressions makes it difficult to retrieve appropriate data in both exact-match keyword search and vector search unless an embedding model has learned expressions such as technical terms and abbreviations.

### SUMMARY

The present disclosure described herein provides an information processing system including a memory that stores terms and corresponding texts in association with each other, the corresponding texts each corresponding to a respective one of the terms; and circuitry that receives input of an input text, identifies a term associated with a corresponding text that is similar to the input text among the corresponding texts, based on similarities between the input text and the corresponding texts, searches for electronic data, based on the identified term, and outputs a response based on the electronic data retrieved in the search.

The present disclosure described herein provides an information processing method including receiving input of an input text; in a memory that stores terms and corresponding texts in association with each other, the corresponding texts each corresponding to a respective one of the terms, identifying a term associated with a corresponding text that is similar to the input text among the corresponding texts, based on similarities between the input text and the corresponding texts; searching for electronic data, based on the identified term; and outputting a response based on the electronic data retrieved in the searching.

The present disclosure described herein provides a non-transitory recording medium storing a plurality of instructions which, when executed by one or more processors, causes the processors to perform an information processing method including receiving input of an input text; in a memory that stores terms and corresponding texts in association with each other, the corresponding texts each corresponding to a respective one of the terms, identifying a term associated with a corresponding text that is similar to the input text among the corresponding texts, based on similarities between the input text and the corresponding texts; searching for electronic data, based on the identified term; and outputting a response based on the electronic data retrieved in the searching.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A to 1C are each a schematic diagram of an example of a question answering system;

FIG. 2 is a block diagram illustrating an example of a hardware configuration of a computer serving as a question answering server in the question answering system;

FIG. 3 is a block diagram illustrating an example of a functional configuration of the question answering system;

FIG. 4 is a diagram illustrating an example of an overall process of how the question answering system generates an answer using a technical term dictionary;

FIG. 5 is a diagram for describing how the question answering system performs vector search of a technical term dictionary and an electronic document database using an embedding model;

FIG. 6 is a sequence diagram illustrating an example of a process performed by a question answering system according to a first embodiment from receiving of a question to outputting of a response;

FIGS. 7A to 7C each illustrate an example of a question screen displayed by the question answering system according to the first embodiment;

FIG. 8 is a block diagram illustrating an example of a functional configuration of a question answering system according to a second embodiment;

FIG. 9 is a sequence diagram illustrating an example of a process performed by the question answering system according to the second embodiment from receiving of a question to outputting of a response;

FIGS. 10A to 10C each illustrate an example of a question screen displayed by the question answering system according to the second embodiment;

FIG. 11 is a block diagram illustrating an example of a functional configuration of a question answering system according to a third embodiment;

FIG. 12 is a sequence diagram illustrating an example of a process performed by the question answering system according to the third embodiment from receiving of a question to outputting of a response;

FIGS. 13A to 13C each illustrate an example of a question screen displayed by the question answering system according to the third embodiment;

FIG. 14 is a sequence diagram illustrating an example of a process performed by the question answering system to cause a web browser to display an answer text on a question screen;

FIG. 15 is a sequence diagram illustrating an example of a process performed by a question answering system according to a fourth embodiment from receiving of a question to outputting of a response; and

FIG. 16 illustrates an example of a screen displayed by the question answering system according to the fourth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system, an information processing apparatus, an information processing method, and a program according to one or more embodiments of the present disclosure will be described in detail below with reference to the drawings. Note that the information processing system, the information processing apparatus, the information processing method, and the program according to one or more embodiments of the present disclosure are not limited to those described below. In the description below, identical or equivalent members and functions are denoted by identical names and reference signs, and detailed description thereof is omitted as appropriate.

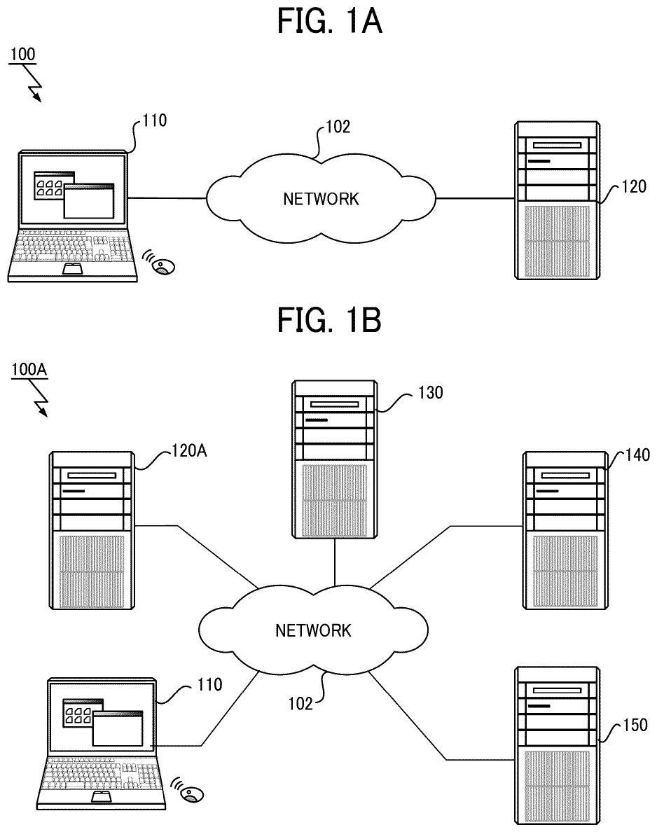

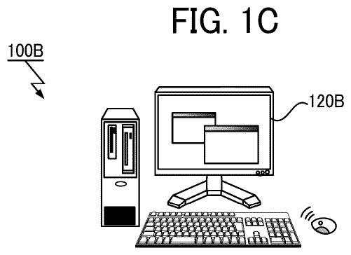

An overall configuration of a question answering system serving as an information processing system according to one or more embodiments of the present disclosure will be described below with reference to FIGS. 1A to 1C.

FIGS. 1A to 1C are schematic diagrams of a question answering system 100 according to one or more embodiments of the present disclosure. FIG. 1A illustrates the question answering system 100 implemented by a client-server configuration.

The question answering system 100 illustrated in FIG. 1A includes a client terminal 110 and a question answering server 120 that are connected to each other via a network 102.

The client terminal 110 is an information terminal such as a personal computer (PC), a tablet computer, or a smartphone. The client terminal 110 has installed thereon a browser and an application that enable communication with the question answering server 120. A user uses the browser or application on the client terminal 110 to send a question to the question answering server 120 and receive an answer. For convenience of the explanation, FIG. 1A illustrates a single client terminal 110. However, the question answering system 100 may include multiple client terminals 110.

The question answering server 120 has a web server function. Thus, the question answering server 120 receives a question from the client terminal 110, generates an answer to the question based preferably on the retrieval-augmented generation (RAG) technique, and returns the answer to the client terminal 110. The question answering server 120 may be a physical machine or a virtual machine that operates on cloud infrastructure. The question answering server 120 may be implemented by one or more computers. In a specific embodiment, a question is an inquiry from a user to the question answering system 100, written in a natural language. An answer is a response to the question. For example, an answer may be a (final) reply to the question or another question for asking about the question.

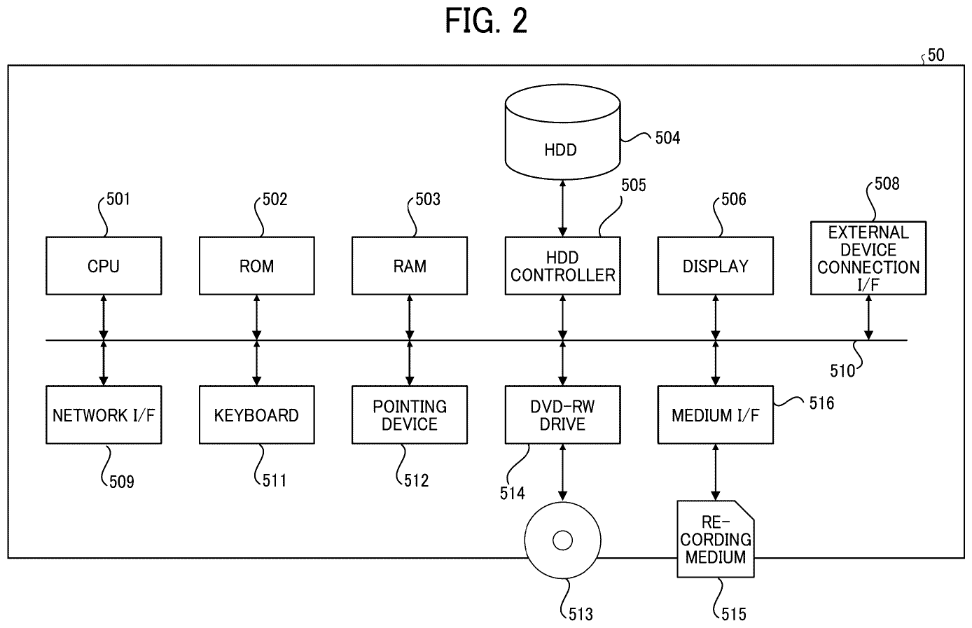

A configuration of one or more computers 50 that implement the question answering server 120 will be described next with reference to FIG. 2. FIG. 2 is a block diagram illustrating an example of a hardware configuration of each of the one or more computers 50 that implement the question answering server 120. Each of the one or more computers 50 is, for example, a general-purpose computer.

As illustrated in FIG. 2, the computer 50 includes a central processing unit (CPU) 501, a read-only memory (ROM) 502, a random access memory (RAM) 503, a hard disk drive (HDD) 504, an HDD controller 505, and a display 506. The computer 50 further includes an external device connection interface (I/F) 508, a network I/F 509, a data bus 510, a keyboard 511, a pointing device 512, a digital versatile disc rewritable (DVD-RW) drive 514, and a medium I/F 516.

The CPU 501 controls the entire operation of the computer 50. The ROM 502 stores programs, such as an initial program loader (IPL), for driving the CPU 501. The RAM 503 is used as a work area for the CPU 501.

The HDD 504 stores various types of data such as a program. The HDD controller 505 controls reading or writing of various types of data from or to the HDD 504 under the control of the CPU 501. The display 506 displays various types of information, such as a cursor, a menu, a window, a text, or an image. The display 506 displays a question screen, for example.

The external device connection I/F 508 is an interface for connecting various external devices to the computer 50. Examples of the external devices include a Universal Serial Bus (USB) memory and a printer. The network I/F 509 is an interface for performing data communication using the network 102. The bus line 510 is, for example, an address bus or a data bus for electrically connecting the components such as the CPU 501 illustrated in FIG. 2 to one another.

The keyboard 511 is one example of an input device provided with a plurality of keys for allowing a user to input characters, numerals, or various instructions. The pointing device 512 is another example of the input device that allows the user to select or execute a specific instruction, select a target for processing, or move the cursor. The DVD-RW drive 514 controls reading or writing of various types of data from or to a DVD-RW 513, which is an example of a removable recording medium. The removable recording medium is not limited to a DVD-RW and may be, for example, a digital versatile disc recordable (DVD-R). The medium I/F 516 controls reading or writing (storing) of data from or to a recording medium 515 such as a flash memory.

In the above description, the computer 50 includes the display 506, the keyboard 511, the pointing device 512, and the DVD-RW drive 514. Alternatively, some of the components illustrated in FIG. 2 including these components may be omitted. The computer 50 may further include another component other than those illustrated in FIG. 2. The hardware configuration of each of the one or more computers 50 that implement the question answering server 120 has been described with reference to FIG. 2. The client terminal 110 and another server apparatus connected via a network can also have substantially the same configuration as that illustrated in FIG. 2 by adding or removing a component as desired.

Some question answering systems employ the RAG technique in combination with a large language model (LLM) to increase the answer accuracy. The RAG technique refers to a technique for increasing the answer accuracy by using an external information search in combination when an LLM generates an answer. The RAG technique acquires a document related to the content (i.e., input text) of a question by vector search, and generates an answer text to the question using the LLM. However, the presence of technical terms and paraphrased expressions that have not been learned by an embedding model used in the vector search makes it difficult to retrieve a correct document. Examples of a method allowing the embedding model to understand the expressions such as technical terms include a method of fine-tuning the embedding model and a method of using a knowledge graph in combination. However, such methods use a large amount of training data.

A conceivable method that can be employed when the preparation of a large amount of training data is difficult is the use of a technical term dictionary (i.e., a key-value store) in which a technical term serves as a key and an explanatory text serves as a value. According to the technique, when the input text includes a word matching a technical term registered in the technical term dictionary, the explanatory text (which is generally written in words that have been learned by the embedding model) of the word is acquired from the technical term dictionary and is added to the input text as supplementary information. This enables retrieval of technical terms or paraphrased expressions that have not been learned by the embedding model. Suppose that a technical term dictionary below is present, for example.

TABLE 1

| Key (technical term) | Value (explanatory text) |
|---|---|
| RAG | Technique for increasing the answer accuracy |
| | using an external information search in combination |
| | when a large language model generates an answer |

When the technical term dictionary above is used, a key “RAG” in the technical term dictionary is hit in response to a question “Please tell me about a technique for increasing the accuracy of RAG”. A document search can be performed by adding a note of the value “RAG is a technique for increasing the answer accuracy using an external information search in combination when a large language model generates an answer”. The technical term “RAG” is not identifiable in response to a question “Please tell me a method for increasing the accuracy in a large language model in combination with a search”, which includes neither the term “RAG” nor the term “retrieval-augmented generation” but includes a phrase intended for RAG. Thus, a user who knows the term “RAG” can retrieve a document not including the term “RAG”, whereas a user who does not know the term “RAG” cannot retrieve a document including the term “RAG” (but not including information describing the term “RAG”). This is because while addition of the explanatory text of the technical term enables exact-match word search, when a related technical term is attempted to be identified from documents not including the technical term, it is difficult to determine the relation by simple keyword-match.

In the RAG technique, processing of two steps is performed for an input question. In the first step, a search-target electronic data group registered in advance is searched to retrieve/extract electronic data related to the question. In the second step, the electronic data extracted in the first step is fed to an LLM to cause the LLM to generate an answer corresponding to the electronic data and the input question (i.e., input text). Thus, when the amount of data is insufficient or incorrect electronic data is extracted at the time of the electronic data search in the first step, it is difficult even for the LLM having high performance to generate a correct answer in the second step.

Accordingly, it is desirable to increase the accuracy in the search for electronic data serving as a basis of the answer. That is, a technique is desired which enables retrieval of electronic data including a technical term even when a question does not include the technical term and thus increases the answer accuracy.

Accordingly, in embodiments described in detail below, a configuration is employed which includes a storage unit, an accepting unit, an identification unit, a search unit, and a response unit. The storage unit stores terms (e.g., technical terms) and corresponding texts (e.g., explanatory texts of the respective technical terms) in association with each other, the corresponding texts each corresponding to a respective one of the terms. The accepting unit receives input of an input text. The identification unit identifies a term associated with a corresponding text that is similar to the input text among the corresponding texts, based on similarities between the input text and the corresponding texts. The search unit searches for electronic data, based on the identified term. The response unit outputs a response based on the electronic data obtained by the search. The electronic data is vectorized information of a text, an image, or the like. Hereinafter, the electronic data is referred to as an electronic document.

The configuration described above enables retrieval of an electronic document (i.e., electronic data) based on a term associated in advance with a similar text of the input text. This thus enables retrieval of an electronic document (i.e., electronic data) including a specific term (e.g., technical term) even when the input text does not include the specific term (e.g., technical term).

In a preferred embodiment in which an answer is generated using the electronic document retrieved in the search, a configuration is employed which includes an output unit. The output unit outputs an output text to a generative model or a large language model, based on the input text and the electronic document retrieved in the search. The response unit returns an answer to the input text, based on an answer text obtained for the output text from the generative model or the large language model. This can increase the answer accuracy.

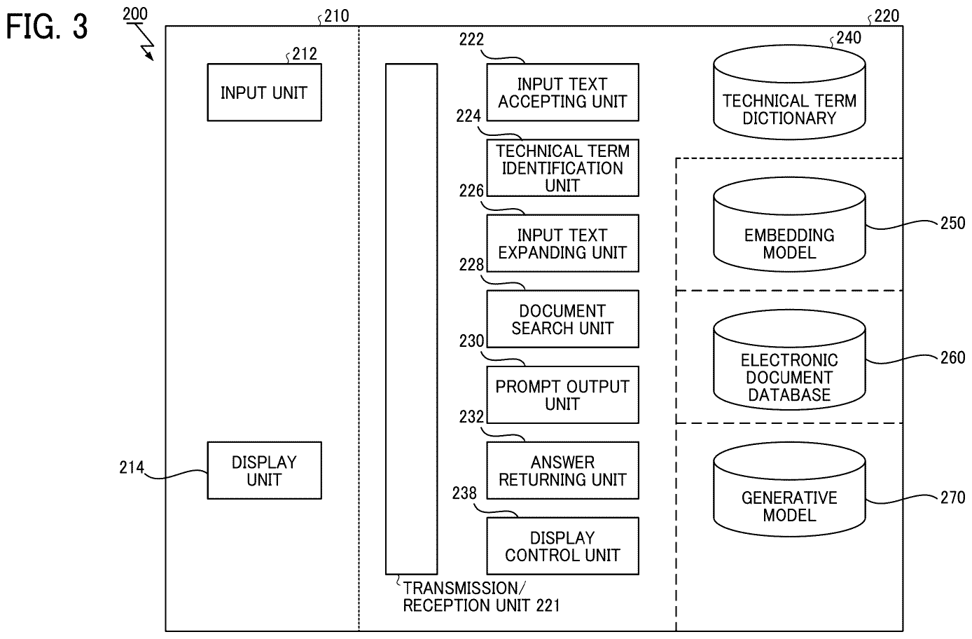

A functional configuration 200 of the question answering system 100 according to one or more embodiments of the present disclosure will be described more specifically below with reference to FIG. 3.

As illustrated in FIG. 3, the question answering system 100 includes, as the functional configuration 200, an input unit 212, a display unit 214, a transmission/reception unit 221, an input text accepting unit 222, a technical term identification unit 224, an input text expanding unit 226, a document search unit 228, a prompt output unit 230, an answer returning unit 232, a display control unit 238, a technical term dictionary 240, an embedding model 250, an electronic document database 260, and a generative model 270.

The input unit 212 and the display unit 214 are functions 210 on the client terminal 110 in the embodiment illustrated in FIG. 1A. The input unit 212 has a function of accepting (receiving) input of a question text (also referred to as an input text or a query) from a user and transmitting the question text (i.e., input text) to the question answering server 120. The display unit 214 has a function of receiving, from the question answering server 120, an answer to the question text (i.e., input text) from the user and displaying the answer on a display.

The components (221 to 270) illustrated in FIG. 3 other than the input unit 212 and the display unit 214 are implemented as functions 220 on the question answering server 120 in the embodiment illustrated in FIG. 1A.

In the technical term dictionary 240, multiple sets of a technical term (i.e., term) and a corresponding text (i.e., explanatory text of the technical term (or term)) are registered. A storage such as the HDD 504 or solid state drive (SSD) or a memory such as the RAM 503 that stores the technical term dictionary 240 serves as a storage unit in the present embodiment. The sets registered in the technical term dictionary 240 may be prepared in advance by a developer of the question answering system 100, may be prepared by a user (e.g., administrator) of the question answering system 100, or may be registered by end users of the question answering system 100 individually or collaboratively. Technical terms may include technical terms in a specific field, abbreviations, paraphrased expressions, and terms specific to a specific organization such as in-house jargon, for example. The corresponding texts are stored in association with the respective terms.

The transmission/reception unit 221 performs various types of communication. The transmission/reception unit 221 receives a request or an operation from the client terminal 110 and transmits screen information to the client terminal 110, for example. The transmission/reception unit 221 may be implemented as a function of a web server, for example.

The input text accepting unit 222 receives, via the transmission/reception unit 221, input of a question text (i.e., input text) transmitted by the input unit 212 in response to a user inputting the question text (i.e., input text). The input text accepting unit 222 may be implemented as a function of the web server, for example. The input text accepting unit 222 serves as an accepting unit in the present embodiment.

The technical term identification unit 224 identifies, with reference to the technical term dictionary 240, a technical term associated with a corresponding text (i.e., explanatory text) that is similar to the question text (i.e., input text) input by the user among the multiple sets registered in the technical term dictionary 240. The technical term or term associated with the corresponding text is hereinafter referred to as a “related term”. In a preferred embodiment, the technical term identification unit 224 identifies a technical term (i.e., related term) associated with the corresponding text (i.e., explanatory text) by vector search. The technical term identification unit 224 serves as an identification unit in the present embodiment. Vector search refers to a search method for finding related information by representing data of a text, an image, or the like as numerical value vectors and calculating a similarity between such vectors, or a search using the method.

The input text expanding unit 226 adds the identified technical term (i.e., related term) to the question text (i.e., input text) input by the user to generate an expanded input text.

The electronic document database 260 is a database that stores a set of one or more electronic documents (i.e., electronic data). The electronic documents may be prepared in advance by a user (e.g., administrator) of the question answering system 100 or may be sequentially created and registered in the electronic document database 260 by end users. The electronic document database 260 may be external to the question answering system 100. For example, a database of an existing document management system may be used.

The document search unit 228 searches the set of the electronic documents in the electronic document database 260 based on the expanded input text generated by the input text expanding unit 226 to acquire one or more hit electronic documents. In a preferred embodiment, the document search unit 228 searches the electronic documents by vector search. However, keyword search or full-text search may be performed. The document search unit 228 serves as a search unit that searches for an electronic document, based on the identified technical term (i.e., related term).

The generative model 270 is a so-called foundation model. In the embodiment described herein, a large language model (LLM) which is one type of foundation model can be used from the viewpoint of handling a text. The large language model is not limited to a specific model and various large language models such as GPT-3.5, GPT-4, Llama2-13B, Richo-13B, Mistral Large, Claude, Gemini, and Granite may be used.

The prompt output unit 230 outputs a prompt text (i.e., output text) to the generative model 270, based on the input text and the electronic document retrieved in the search. The prompt output unit 230 serves as an output unit in the present embodiment.

The answer returning unit 232 returns an answer to the input text input by the user based on the answer text obtained from the generative model 270 for the prompt text (i.e., output text) based on the electronic document retrieved in the search. The answer returning unit 232 outputs the answer to the client terminal 110. The answer returning unit 232 may be implemented as a function of the web server, for example. The answer returning unit 232 serves as a response unit in the present embodiment. When the generative model 270 is not used, the answer returning unit 232 may output information indicating the electronic document retrieved in the search. That is, the answer returning unit 232 outputs a response based on the electronic document retrieved in the search.

The display control unit 238 controls output (e.g., display) in the client terminal 110. The display control unit 238 is an example of a control unit. For example, the display control unit 238 outputs, to the client terminal 110, information for displaying (outputting) a screen including an interface component to receive input of an input text to control display in the client terminal 110. The display control unit 238 may be implemented as a function of the web server, for example. For example, the display control unit 238 may control the client terminal 110 to output sound that prompts input of the input text.

The embedding model 250 is a model for a vectorization process (i.e., embedding) for converting a text such as an explanatory text and sentences in an electronic document into vectors for vector search. The embedding model 250 is used for vectorizing the explanatory texts of the respective sets in the technical term dictionary 240 and electronic documents in the electronic document database 260 to create indices. The embedding model 250 is used for vectorizing the input text and the expanded input text and searching for the corresponding data from the index in order to search the technical term dictionary 240 and the electronic document database 260.

The embedding model 250 is preferably shared for both identification of technical terms in the technical term dictionary 240 and electronic document search in the electronic document database 260 from the viewpoint of reducing resource consumption. However, the usage of the embedding model 250 is not particularly limited. Different embedding models may be used in identification of technical terms in the technical term dictionary 240 and electronic document search in the electronic document database 260.

The embedding model 250 is trained in advance on a large-scale corpus by machine learning. Examples of the embedding model 250 to be used include, but are not limited to, various embedding models such as Multilingual EmbEddings from bidirectional Encoder rEpresentations (ME5), Simple Contrastive Sentence Embedding (SimCSE), and Difference-based Contrastive Learning for Sentence Embeddings (DiffSCE).

The question answering system 100 implemented by the client terminal 110 and the question answering server 120 illustrated in FIG. 1A has been described above. In the embodiment above, the configuration has been described in which the components 221 to 232 used from acceptance of an input text to returning of an answer text, the technical term dictionary 240, the embedding model 250, the electronic document database 260, and the generative model 270 are implemented in the question answering system 100. However, the implementation of the question answering system 100 is not limited to that illustrated in FIG. 1A.

For example, FIG. 1B illustrates a question answering system 100A implemented using multiple servers in a client-server configuration. The question answering system 100A illustrated in FIG. 1B includes a question answering server 120A, an embedding model server 130, a document management server 140, and a generative model server 150. In an embodiment illustrated in FIG. 1B, functions are divided into portions represented by broken lines in FIG. 3 and executed in a distributed manner.

The embedding model server 130 includes the embedding model 250. The document management server 140 includes the electronic document database 260. The generative model server 150 includes the generative model 270. The embedding model server 130, the document management server 140, and the generative model server 150 may be operated and managed by an entity different from that of the question answering server 120. The servers perform communication via an appropriate application programming interface (API) such as a REpresentational State Transfer (REST) API. The distributed implementation illustrated in FIG. 1B and indicated by the broken lines in FIG. 3 is an example. The functions of the multiple servers illustrated in FIG. 1B and FIG. 3 may be collected to one server, and the function of one server may be implemented in multiple servers in a distributed manner.

FIG. 1C illustrates a question answering system 100B implemented on a workstation 120B. As illustrated in FIG. 1C, the question answering system 100B includes the components 221 to 232 used from acceptance of an input text to returning of an answer text, the technical term dictionary 240, the embedding model 250, the electronic document database 260, and the generative model 270 as well as the components 212 and 214, which have been described as functions of the client terminal 110 in FIGS. 1A and 1B, are implemented on a single computer. For example, the generative model 270 may operate on a local PC by using a local LLM framework such as Ollama or Podman AI Lab extension function.

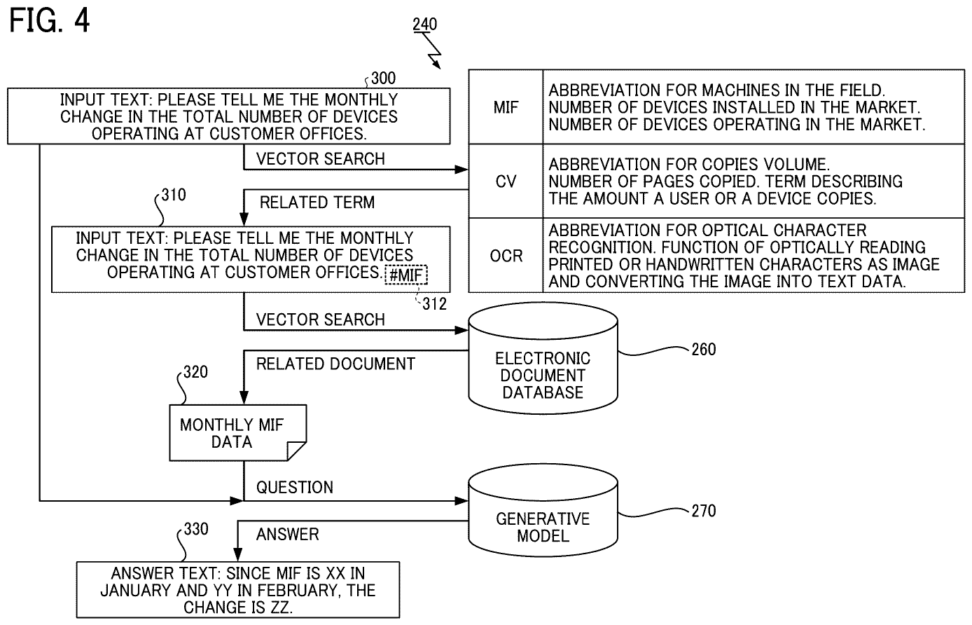

An overall process performed by the question answering system 100 according to one or more embodiments to generate an answer using a technical term dictionary will be described by focusing on a data flow with reference to FIG. 4. The input text accepting unit 222 receives an input text 300 that has been input from the user via the input unit 212 and transmitted via the transmission/reception unit 221. The input text 300 is “Please tell me the monthly change in the total number of devices operating at customer offices.” in the example currently described.

The technical term identification unit 224 performs vector search on the technical term dictionary 240 to identify a related technical term (i.e., related term). For example, the technical term identification unit 224 calculates similarities between a vector of the input text 300 and vectors of the explanatory texts included in the technical term dictionary 240, and identifies the technical term related to the input text 300 based on the similarities. The technical term dictionary 240 stores an explanatory text in association with each of three terms “MIF”, “CV”, and “OCR”. The explanatory text of the term “MIF” is “Abbreviation for machines in the field. Number of devices installed in the market. Number of devices operating in the market.”. For the input text 300 “Please tell me the monthly change in the total number of devices operating at customer offices.”, the explanatory text of the term “MIF” is determined to have a relatively high similarity and the term “MIF” is identified as a related term.

The input text expanding unit 226 adds a related term 312 (i.e., the identified related term) to the input text 300 to generate an expanded input text 310. Thus, the expanded input text 310 includes the input text 300 and the identified related term. The related term “MIF” 312 is added along with a tag “#” to the input text 300 “Please tell me the monthly change in the total number of devices operating at customer offices.”.

The document search unit 228 searches the electronic document database 260 for a related electronic document 320 using the expanded input text 310. In this example, the electronic document 320 named “monthly MIF data” is hit by the search. The electronic document 320 hit by the search is the electronic document related to the input text.

The original input text 300 (or the expanded input text 310) and the related electronic document 320 are used together to generate a prompt text. The prompt text is output to the generative model 270, and an answer text 330 is obtained. In the example currently described, for the input text 300 “Please tell me the monthly change in the total number of devices operating at customer offices.”, the answer text 330 “Since MIF is XX in January and YY in February, the change is ZZ.” is obtained. Information “MIF is XX in January and YY in February” in the answer text 330 is based on the content of the related electronic document 320 (i.e., related document). Thus, a specific answer is returned based on the content of the related document 320 in response to the input text 300. The prompt text output to the generative model 270 includes an instruction to the generative model 270, the input text 300, and the related electronic document 320. An example of the prompt text output to the generative model 270 is, for example, “Please create an answer to the following question using the content of the following related document. Question: Please tell me the monthly change in the total number of devices operating at customer offices. Related document: content of the related document”.

As illustrated in FIG. 4, a related technical term (i.e., related term 312) obtained by performing vector search on the technical term dictionary 240 using the input text 300 is added to the input text 300, and the RAG technique is employed to generate an answer. Even when the input text 300 does not include a complete sentence of the explanatory text of the technical term, a semantically close technical term can be acquired as the related term by vector search by considering the semantic distance. Addition of the technical term (i.e., related term) to the input text 300 enables the retrieval of an electronic document only including the technical term (i.e., the related term).

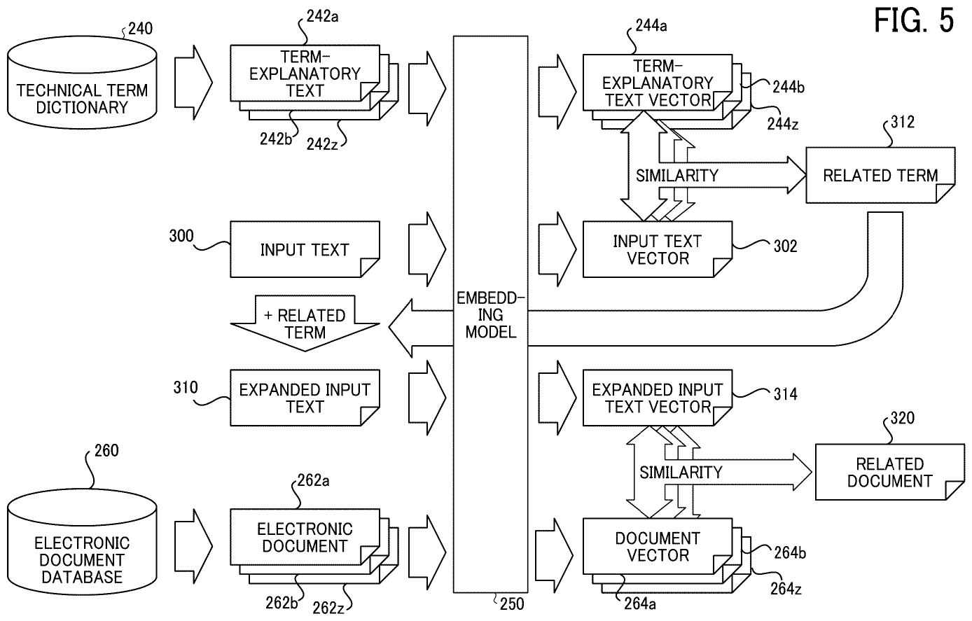

Vector search on the technical term dictionary 240 and the electronic document database 260 using the embedding model 250 will be described below with reference to FIG. 5.

In the embodiment described herein, to enable vector search, a search target and a query text (e.g., input text or expanded input text) are vectorized using the embedding model 250.

Search-target explanatory texts 242a to 242z associated with respective terms of respective sets in the technical term dictionary 240 are respectively vectorized by the embedding model 250 into explanatory text vectors 244a to 244z associated with the respective terms, and are thus indexed. The explanatory text vectors 244 are generally prepared in advance in a preparation phase. The explanatory texts may be generally stored in a storage in a vector format. In a query phase, the input text 300 is vectorized and converted into an input text vector 302. Based on vector similarities between the input text vector 302 and the explanatory text vectors 244a to 244z of a group, the explanatory text vector 244 having the highest vector similarity (at least approximately) is acquired, and the related term 312 associated with the explanatory text vector 244 is obtained.

The related term 312 is added to the input text 300, so that the expanded input text 310 is generated. A predetermined threshold value may be provided for the vector similarity for screening. When the vector similarity of the related term 312 with the largest vector similarity is less than a threshold value, the related term 312 is not added and the input text 300 is used as the expanded input text 310. The number of related terms 312 is not limited to one. When there are multiple related terms 312 with the vector similarity that is greater than or equal to the predetermined threshold value, the multiple related terms 312 may be identified.

Examples of the vector similarity to be used may include, but are not particularly limited to, the cosine similarity and the Euclidean distance. In addition, examples of the algorithm that can be used for searching for a match to the input text vector 302 from among the multiple explanatory text vectors 244 include, but are not limited to, various existing algorithms such as linear search, space partitioning, nearest neighbor search (NNS) using locality-sensitive hashing, approximate nearest neighbor search, nearest neighbor distance ratio, and closest pair problem.

The same applies to search-target electronic documents 262a to 262z in the electronic document database 260. The electronic documents 262a to 262z are respectively vectorized by the embedding model 250 and converted into document vectors 264a to 264z associated with paths of the electronic documents, and are thus indexed. The document vectors 264 are generally prepared in advance in the preparation phase. In the query phase, the expanded input text 310 is vectorized and converted into an expanded input text vector 314. Based on vector similarities between the expanded input text vector 314 and the document vectors 264a to 264z of a group, the document vector 264 having the highest vector similarity (at least approximately) is acquired, and the related document 320 associated with the document vector 264 is obtained. The vector similarity is the same as that in the case of the technical term dictionary 240.

As described above, the technical term identification unit 224 identifies the related term 312 associated with the similar explanatory text, based on the vector similarities between the input text vector 302 converted from the input text 300 using the embedding model 250 and the explanatory text vectors 244 converted from the respective explanatory texts 242 in multiple sets using the embedding model 250. Likewise, the document search unit 228 searches for the related document 320, based on the vector similarities between the expanded input text vector 314 converted, using the same embedding model 250, from the expanded input text 310 in which the related term 312 is added to the input text 300, and the document vectors 264 converted, using the embedding model 250, from the respective electronic documents 262 in the electronic document database 260.

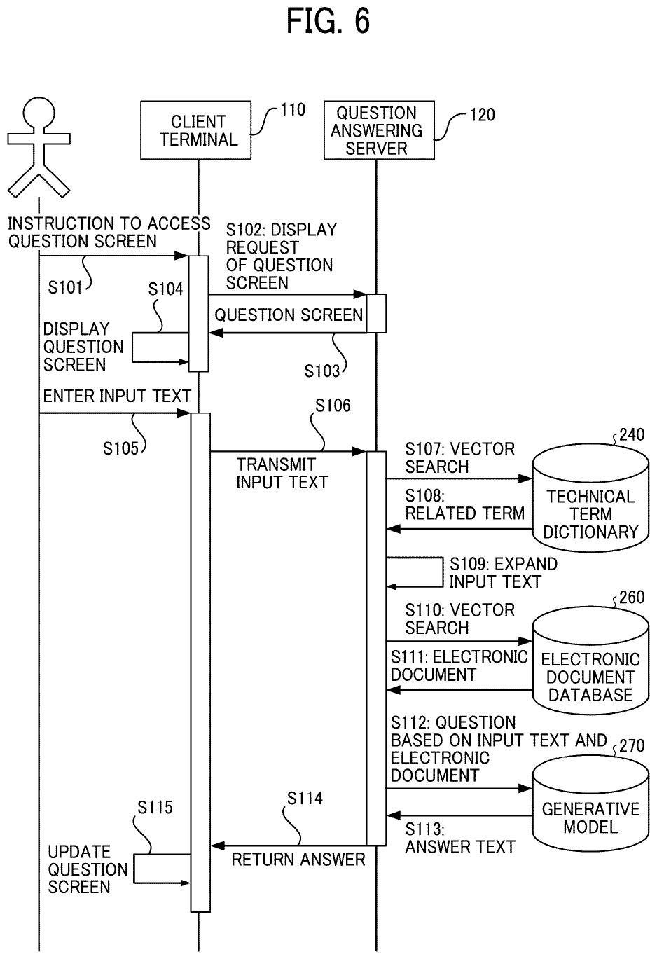

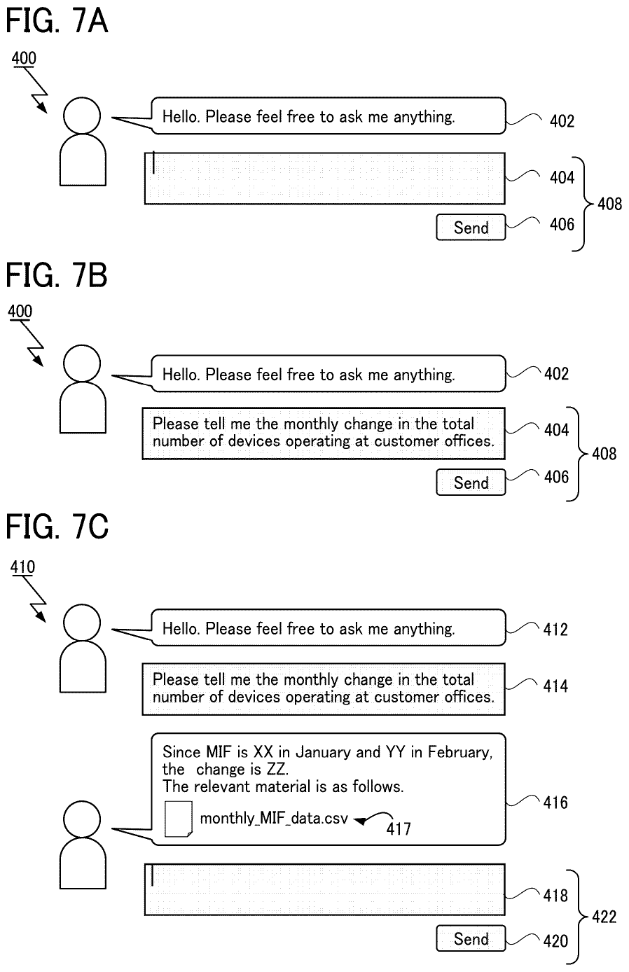

A process performed by the question answering system 100 according to a first embodiment from receiving of a question to outputting of a response will be described below with reference to FIGS. 6 to 7C. FIG. 6 is a sequence diagram illustrating the process performed by the question answering system 100 according to the first embodiment of the present disclosure from receiving of a question to outputting of a response. FIGS. 7A to 7C each illustrate a question screen displayed by the question answering system 100 according to the first embodiment of the present disclosure.

The process illustrated in FIG. 6 starts when a user designates a Uniform Resource Locator (URL) of a question screen and inputs an instruction to access the question screen, for example, via a browser of the client terminal 110 in step S101. In response to the instruction input from the user in step S101, the client terminal 110 requests the question answering server 120 to display the question screen in step S102. In step S103, the question answering server 120 returns the question screen to the client terminal 110 in response to the request. For example, the display control unit 238 outputs information for displaying a question screen 400 to the client terminal 110 to control the display. In step S104, the client terminal 110 displays the question screen 400 on the browser, for example.

FIG. 7A illustrates the question screen 400. The question screen 400 illustrated in FIG. 7A includes a guidance text 402 prompting input of a question, a text box 404 for inputting a question, and a send button 406 for receiving an instruction to send content input in the text box 404 to the question answering server 120. The text box 404 and the send button 406 serve as a user interface component 408 to receive input of an input text in the first embodiment.

In step S105, the user inputs the input text 300 on the question screen 400 via the input unit 212. FIG. 7B illustrates the question screen 400 after the input text 300 is input. In response to the user inputting the input text 300 to the text box 404 and clicking or tapping the send button 406 illustrated in FIG. 7B, the process proceeds to step S106. In step S106, the client terminal 110 transmits the input text 300 to the question answering server 120, and the input text accepting unit 222 of the question answering server 120 receives the input text 300.

In step S107, the technical term identification unit 224 of the question answering server 120 performs vector search on the technical term dictionary 240 using the input text 300. In step S108, the question answering server 120 acquires a result of the vector search, i.e., the related term 312. In step S109, the input text expanding unit 226 of the question answering server 120 adds the related term 312 to the input text 300 to generate the expanded input text 310. In step S110, the document search unit 228 of the question answering server 120 performs vector search on the electronic document database 260 using the expanded input text 310. In step S111, the question answering server 120 acquires a result of the vector search, i.e., the related document 320.

In step S112, the prompt output unit 230 of the question answering server 120 transmits a prompt text using the input text 300 and the related document 320 to the generative model 270.

In step S113, the question answering server 120 acquires an answer text from the generative model 270. In step S114, the answer returning unit 232 of the question answering server 120 uses the answer text from the generative model 270 to return (output) an answer to the client terminal 110.

For example, the display control unit 238 outputs information for displaying a question screen 410 including the answer to the client terminal 110 to control the display. In step S115, based on the answer, the client terminal 110 updates the question screen on the browser, for example.

FIG. 7C illustrates the question screen 410 including the answer. The question screen 410 illustrated in FIG. 7C includes, after a display 412 that is the same as that in FIGS. 7A and 7B, a display 414 of the input text that has been transmitted via the text box 404, a display 416 of the answer to the input text, a text box 418 for further inputting an input text, and a send button 420. The display 416 of the answer may be attached with a retrieved electronic document 417, for example. The display 416 of the answer is a user interface component to output an answer. The text box 418 and the send button 420 serve as a user interface component 422 to receive input of a next input text.

According to the first embodiment described above, even when an input text does not include a specific technical term, electronic documents can be searched by adding a related term obtained by vector search of the technical term dictionary 240. This enables retrieval of an electronic document including a technical term that is not included in the input text but is semantically related to the input text. Since the accuracy of the electronic document search in the first step increases, the accuracy of the answer generated by the generative model 270 in the second step increases.

In the first embodiment described above, a series of processing steps of identifying a related term in response to a user's input of an input text, performing document search using the related term, and generation of an answer using an electronic document retrieved in the document search using the related term is completed without user intervention. However, the configuration is not limited to the above embodiment, and user intervention may occur in the middle, or a second answer may be requested under reset conditions after a first answer is obtained.

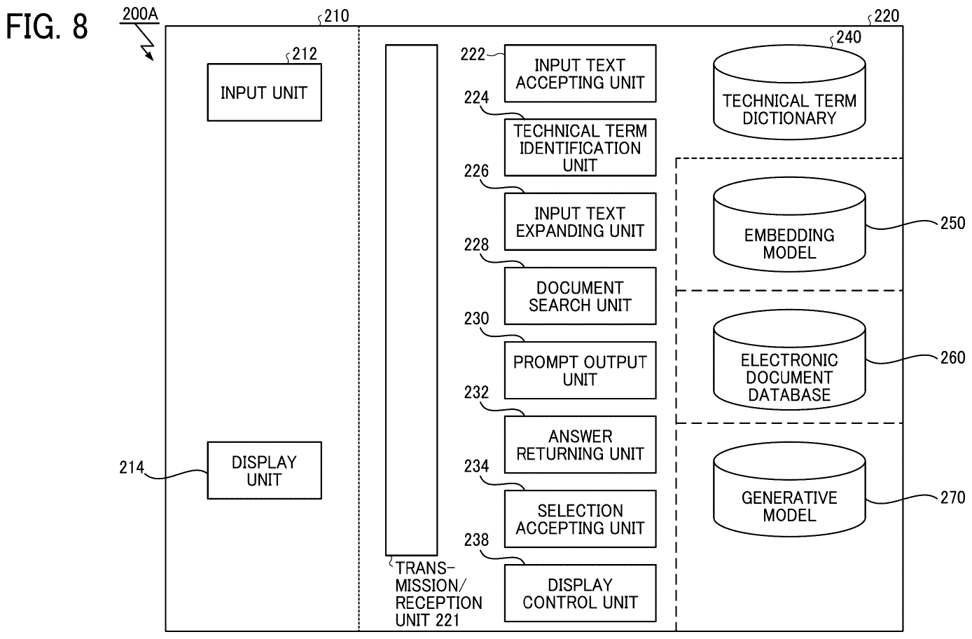

With reference to FIGS. 8 to 10C, the description will be given of the question answering system 100 according to a second embodiment that allows re-designation of a related term used in document search after providing the first answer and then provides the second answer.

FIG. 8 is a block diagram illustrating the question answering system 100 according to the second embodiment of the present disclosure. As illustrated in FIG. 8, the question answering system 100 according to the second embodiment has a functional configuration 200A that further includes a selection accepting unit 234 in addition to those illustrated in FIG. 3 (i.e., the input unit 212, the display unit 214, the transmission/reception unit 221, the input text accepting unit 222, the technical term identification unit 224, the input text expanding unit 226, the document search unit 228, the prompt output unit 230, the answer returning unit 232, the display control unit 238, the technical term dictionary 240, the embedding model 250, the electronic document database 260, and the generative model 270).

The question answering system 100 according to the second embodiment has a configuration similar to that of the question answering system 100 according to the first embodiment. Thus, differences will be mainly described, and points for which description is omitted are assumed to have the same configuration as in the first embodiment within a range without contradiction.

The answer returning unit 232 in the second embodiment returns a first answer to the input text input by the user, based on an answer text obtained for a prompt text (i.e., output text) from the generative model 270 and one or more identified related terms. For example, the display control unit 238 outputs, to the client terminal 110, information for displaying (outputting) a screen including a user interface component to output the first answer and to receive input of selection for the one or more identified related terms to control the display on the client terminal 110. For example, the display control unit 238 may control the client terminal 110 to output sound that prompts input of selection for a related term while outputting the first answer. The second embodiment is configured such that, in response to the first answer from the answer returning unit 232, a user can designate a removal-target related term which the user considers unnecessary. The selection accepting unit 234 receives selection of a related term designated to be removed from among the one or more related terms included in the first answer.

After the selection accepting unit 234 receives the selection, the input text expanding unit 226 adds the related term(s) remaining after the designation to the original input text 300 to generate a second expanded input text 310′. Based on the second expanded input text 310′, the document search unit 228 re-searches the electronic document database 260 and acquires a hit second electronic document. Based on the input text and the second electronic document retrieved in the re-search, the prompt output unit 230 outputs a second prompt text to the generative model 270.

Based on a second answer text output for the second prompt text from the generative model 270, the answer returning unit 232 returns a second answer to the input text input by the user.

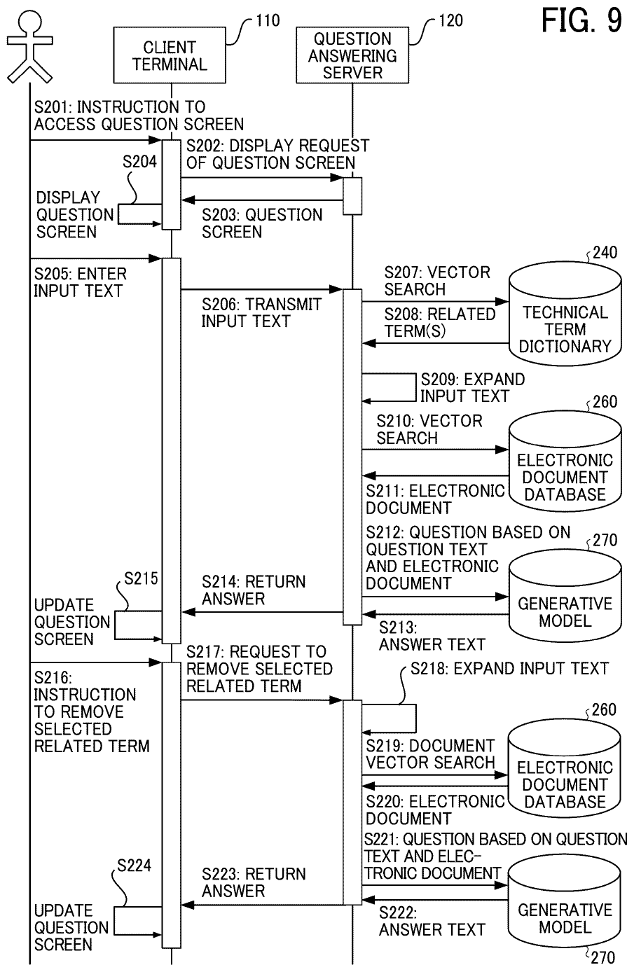

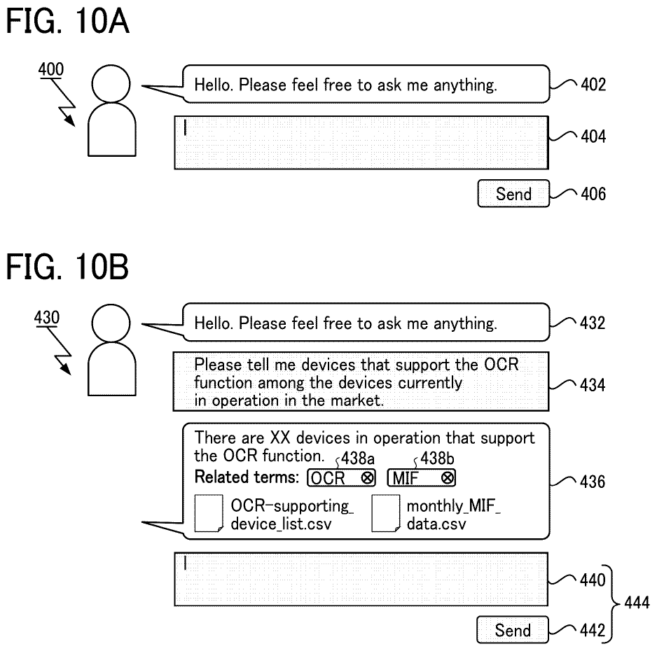

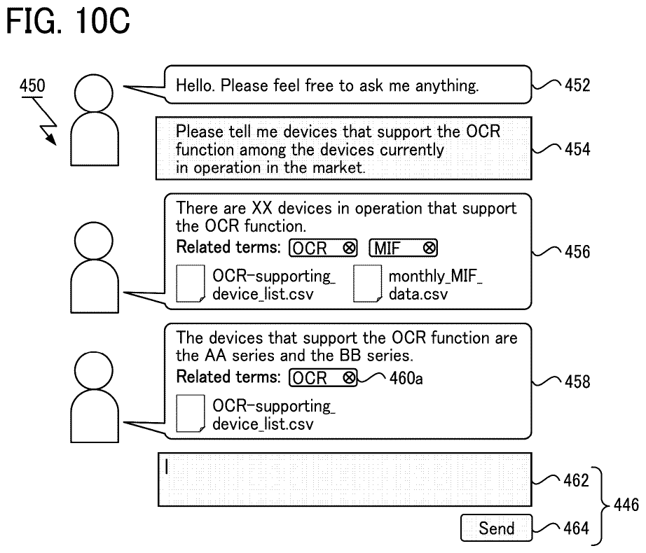

FIG. 9 is a sequence diagram illustrating a process performed by the question answering system 100 according to the second embodiment of the present disclosure from receiving of a question to outputting of a response. FIGS. 10A to 10C each illustrate a screen displayed by the question answering system 100 according to the second embodiment of the present disclosure.

The process illustrated in FIG. 9 starts when a user inputs an instruction to access a question screen in step S201. The client terminal 110 requests the question answering server 120 to display the question screen in step S202. In step S203, the question answering server 120 returns the question screen to the client terminal 110 in response to the request. For example, the display control unit 238 outputs information for displaying the question screen 400 to the client terminal 110 to control the display. In step S204, the client terminal 110 displays the question screen 400 on the browser, for example. FIG. 10A illustrates the question screen 400. The question screen 400 illustrated in FIG. 10A is the same as that illustrated in FIG. 7A.

In step S205, the user inputs the input text 300 on the question screen 400 via the input unit 212. In step S206, the client terminal 110 transmits the input text 300 to the question answering server 120.

The technical term identification unit 224 of the question answering server 120 performs vector search on the technical term dictionary 240 using the input text 300 in step S207, and acquires one or more related terms 312 in step S208. In step S209, the input text expanding unit 226 of the question answering server 120 adds all the acquired related terms 312 to the input text 300 to generate the first expanded input text 310.

The document search unit 228 of the question answering server 120 performs vector search on the electronic document database 260 using the first expanded input text 310 in step S210, and acquires the first related document 320 in step S211. The prompt output unit 230 of the question answering server 120 transmits a first prompt text using the input text 300 and the first related document 320 to the generative model 270 in step S212, and acquires a first answer text from the generative model 270 in step S213. In step S214, the answer returning unit 232 of the question answering server 120 uses the first answer text from the generative model 270 to return (output) a first answer to the client terminal 110. The first answer further includes the one or more related terms used in the above search as well as the first answer text. The display control unit 238 outputs, to the client terminal 110, information for displaying a question screen, which displays the first answer and displays the one or more identified related terms in a selectable manner for removal, to control the display. In step S215, based on the first answer, the client terminal 110 updates the question screen on the browser, for example.

FIG. 10B illustrates a question screen 430 including the first answer. The question screen 430 illustrated in FIG. 10B includes, after a display 432 that is the same as that in FIG. 10A, a display 434 of the input text that has been transmitted via the text box 404, a display 436 of the answer to the display 434 of the input text, a text box 440 for further inputting an input text, and a send button 442. The display 436 of the answer to the input text further includes remove buttons 438a and 438b each for receiving designation of a related term to be removed among the multiple related terms. The example in FIG. 10B displays the related terms “OCR” and “MIF” and the remove buttons 438a and 438b for designating the respective related terms to be removed. The display 436 of the answer including the remove buttons 438a and 438b serves as a user interface component to output the first answer text and to output the one or more related terms in a selectable manner in the present embodiment. When the user is satisfied with the first answer, the user may end the question. In this case, the text box 440 and the send button 442 serve as a user interface component 444 to receive input of a next input text.

In response to the remove button 438 being clicked or tapped on the question screen 430, the client terminal 110 receives an instruction to remove the selected related term from the user in step S216. In step S217, the client terminal 110 transmits a request to remove the selected related term to the question answering server 120, and the selection accepting unit 234 of the question answering server 120 receives the selected related term to be removed.

In step S218, the input text expanding unit 226 of the question answering server 120 adds the related term remaining after removal among the last used related terms 312 to the input text 300 to generate a second expanded input text 310′. The document search unit 228 of the question answering server 120 performs vector search on the electronic document database 260 using the second expanded input text 310′ in step S219, and acquires a second related document 320′ in step S220.

The prompt output unit 230 of the question answering server 120 transmits a second prompt text using the input text 300 and the second related document 320′ to the generative model 270 in step S221, and acquires a second answer text from the generative model 270 in step S222. In step S223, the answer returning unit 232 of the question answering server 120 uses the second answer text from the generative model 270 to return a second answer to the client terminal 110. For example, the display control unit 238 outputs information for displaying a question screen including the second answer to the client terminal 110 to control the display. In step S224, based on the second answer, the client terminal 110 updates the question screen on the browser, for example. The second answer includes the one or more related terms used in the above search as well as the second answer text.

FIG. 10C illustrates a question screen 450 including the second answer. The question screen 450 illustrated in FIG. 10C includes, following displays 452 to 456 that are the same as those in FIG. 10B, a display 458 of the second answer obtained after the selected related term has been removed, a text box 462 for inputting an input text, and a send button 464. The display 458 of the second answer displays a remove button 460a for receiving designation of a related term to be removed. In the example illustrated in FIG. 10C, the related term “MIF” is removed from among the related term “OCR” and the related term “MIF” that have been displayed in the display 456 of the first answer. In the present embodiment, the display 458 of the second answer serves as a user interface component to output the second answer.

When the user is satisfied with the second answer, the user may end the question. In this case, the text box 462 and the send button 464 serve as a user interface component 466 to receive input of a next input text. When the user is not satisfied with the second answer, the user may return to the display 456 of the first answer for re-selection. Alternatively, when the display 458 of the second answer includes multiple related terms, the user may further remove a related term to sequentially ask questions to obtain a third answer, a fourth answer, and so on.

According to the second embodiment described above, even when a related term that a user considers inappropriate is identified, electronic documents can be searched by removing the related term. This enables an electronic document including a technical term that is not included in an input text but is semantically related to the input text to be searched for with a high accuracy by reflecting the user's intention, and thus can increase the accuracy of the answer obtained by the generative model 270.

In the second embodiment described above, the user selects the remove button 438 corresponding to a related term desired to be removed. Thus, a related term to be used in document search is designated negatively. However, how a related term is selected is not limited to this case, and a related term to be used in document search may be explicitly selected.

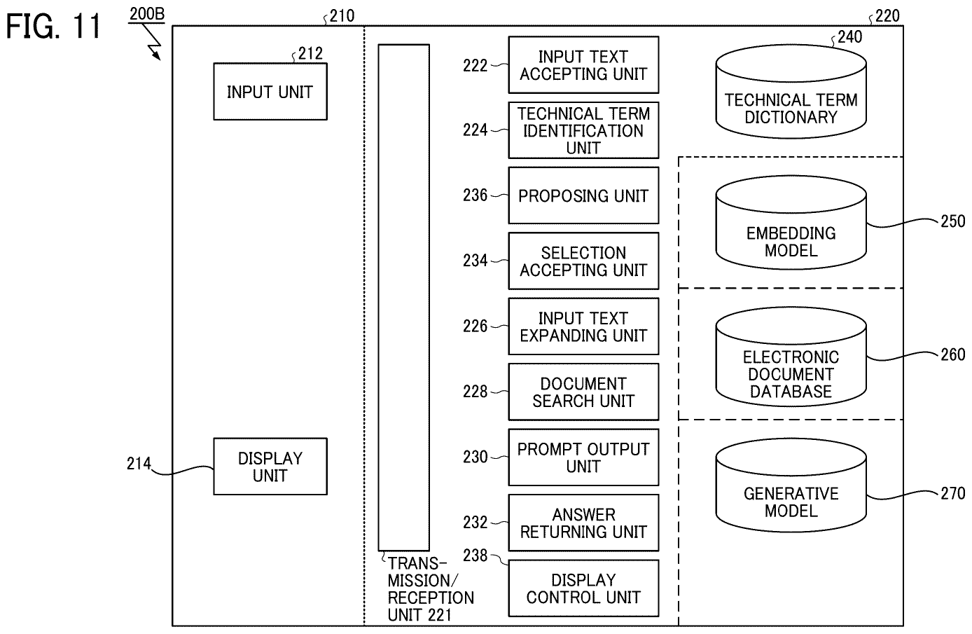

With reference to FIGS. 11 to 13C, the description will be given of the question answering system 100 according to a third embodiment that allows editing of a related term used in document search before providing the first answer and then provides an answer.

FIG. 11 is a block diagram illustrating the question answering system 100 according to the third embodiment of the present disclosure. As illustrated in FIG. 11, the question answering system 100 according to the third embodiment has a functional configuration 200B that further includes the selection accepting unit 234 and a proposing unit 236 in addition to those illustrated in FIG. 3 (i.e., the input unit 212, the display unit 214, the transmission/reception unit 221, the input text accepting unit 222, the technical term identification unit 224, the input text expanding unit 226, the document search unit 228, the prompt output unit 230, the answer returning unit 232, the display control unit 238, the technical term dictionary 240, the embedding model 250, the electronic document database 260, and the generative model 270).

The question answering system 100 according to the third embodiment has substantially the same configuration as the question answering system 100 according to the first embodiment. Thus, differences will be mainly described, and points for which description is omitted are assumed to have the same configuration as in the first embodiment within a range without contradiction.

In the third embodiment, the proposing unit 236 proposes one or more related terms identified by the technical term identification unit 224 to the user before the input text expanding unit 226 expands the input text. For example, the display control unit 238 outputs, to the client terminal 110, information for displaying (outputting) a screen including user interface components for receiving input of selection for the one or more identified related terms to control the display on the client terminal 110. For example, the display control unit 238 may control the client terminal 110 to output sound that prompts input of selection for a related term. The selection accepting unit 234 receives a user's selection of at least one related term among the one or more proposed related terms. The input text expanding unit 226 adds the technical term (i.e., related term) that is identified and selected by the user to the question text (i.e., input text) input by the user to generate an expanded input text. The document search unit 228 searches the electronic document database 260 based on the expanded input text generated through user intervention. The prompt output unit 230 and the answer returning unit 232 operate in the same manner as in the first embodiment.

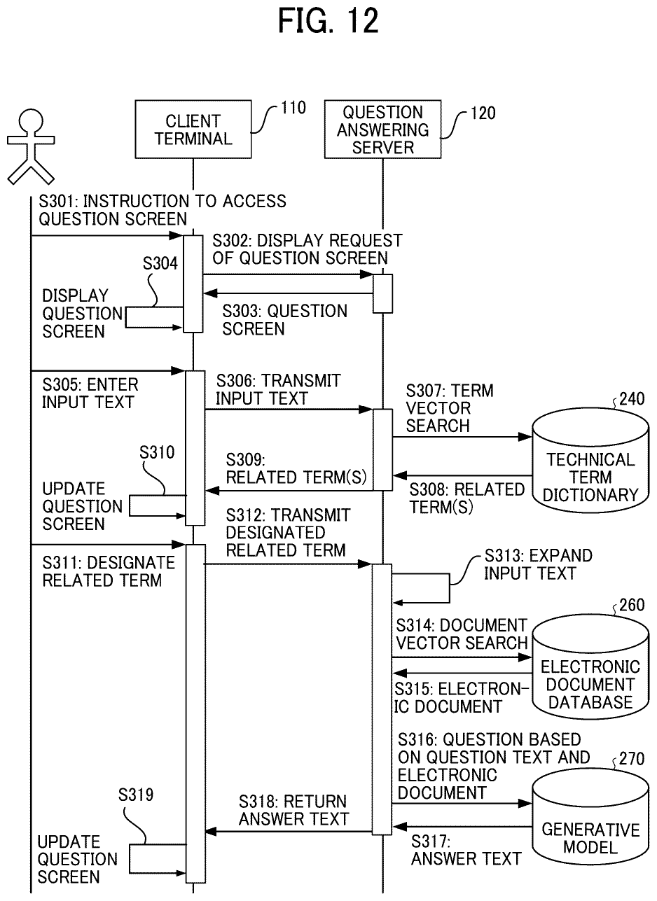

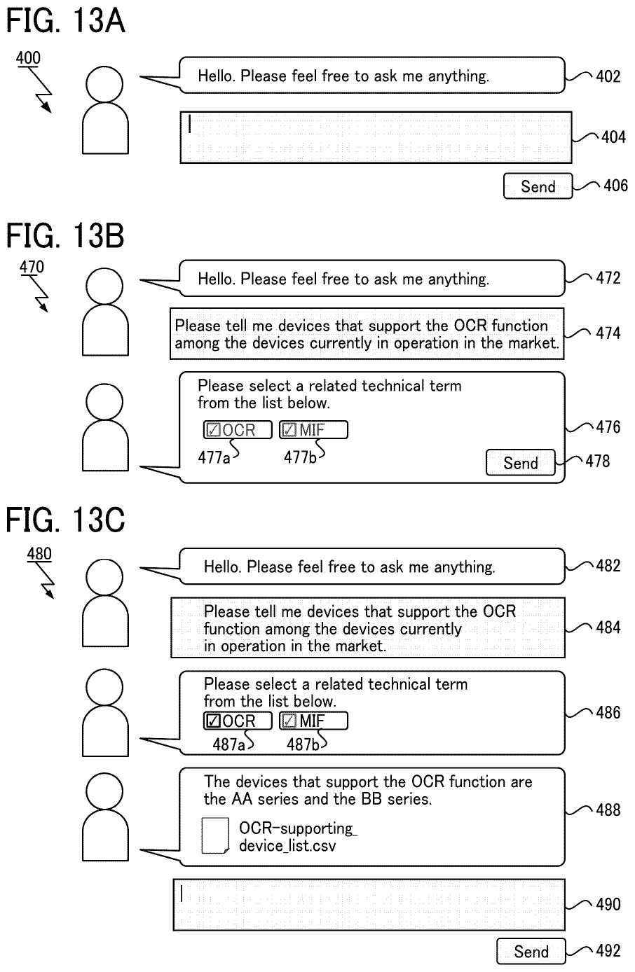

FIG. 12 is a sequence diagram illustrating a process performed by the question answering system 100 according to the third embodiment of the present disclosure from receiving of a question to outputting of a response. FIGS. 13A to 13C each illustrate a screen displayed by the question answering system 100 according to the third embodiment of the present disclosure.

The process illustrated in FIG. 12 starts when a user inputs an instruction to access a question screen in step S301. The client terminal 110 requests the question answering server 120 to display the question screen in step S302. In step S303, the question answering server 120 returns the question screen to the client terminal 110 in response to the request. For example, the display control unit 238 outputs information for displaying the question screen 400 to the client terminal 110 to control the display. In step S304, the client terminal 110 displays the question screen 400 on the browser, for example. FIG. 13A illustrates the question screen 400.

The question screen 400 illustrated in FIG. 13A is the same as that illustrated in FIGS. 7A and 10A.

In step S305, the user inputs the input text 300 on the question screen 400 via the input unit 212. In step S306, the client terminal 110 transmits the input text 300 to the question answering server 120.

The technical term identification unit 224 of the question answering server 120 performs vector search on the technical term dictionary 240 using the input text 300 in step S307, and acquires one or more related terms 312 in step S308. In step S309, the proposing unit 236 of the question answering server 120 proposes the one or more identified related terms 312. For example, the display control unit 238 outputs, to the client terminal 110, information for displaying a question screen, which displays the one or more identified related terms in a selectable manner for designation, to control the display. In step S310, based on the proposal of the one or more related terms 312, the client terminal 110 updates the question screen.

FIG. 13B illustrates a question screen 470 including the proposal of the one or more identified related terms 312. The question screen 470 illustrated in FIG. 13B includes, following a display 472 that is the same as the display of the guidance text 402 in FIG. 13A, a display 474 of the input text that has been transmitted via the text box 404 and a proposal display 476 of the related terms that are selectable. The proposal display 476 of the related terms displays designation buttons 477a and 477b each for receiving designation of a related term to be selected among the multiple related terms and a send button 478 to transmit the designated selected related term. The example in FIG. 13B displays the related terms “OCR” and “MIF” and the designation buttons 477a and 477b for explicitly designating the respective related terms. The proposal display 476 including the designation buttons 477a and 477b serves as a user interface component to output one or more related terms in a selectable manner in the third embodiment.

In response to the designation button 477 being selected and the send button 478 being clicked or tapped on the question screen 470, the client terminal 110 receives a selection instruction from the user in step S311. In step S312, the client terminal 110 transmits the designated related term to the question answering server 120, and the selection accepting unit 234 of the question answering server 120 receives the designated related term.

In step S313, the input text expanding unit 226 of the question answering server 120 adds the designated related term 312 to the input text 300 to generate the expanded input text 310. The document search unit 228 of the question answering server 120 performs vector search on the electronic document database 260 using the expanded input text 310 in step S314, and acquires the related document 320 in step S315. The prompt output unit 230 of the question answering server 120 transmits a prompt text using the input text 300 and the related document 320 to the generative model 270 in step S316, and acquires an answer text from the generative model 270 in step S317. In step S318, the answer returning unit 232 of the question answering server 120 uses the answer text from the generative model 270 to return an answer to the client terminal 110. For example, the display control unit 238 outputs information for displaying a question screen including the answer to the client terminal 110 to control the display. In step S319, based on the answer, the client terminal 110 updates the question screen on the browser, for example.

FIG. 13C illustrates a question screen 480 including the answer. The question screen 480 illustrated in FIG. 13C includes, after displays 482 and 484 that are the same as those in FIG. 13B, a display 486 of the selection of the related term that has been transmitted, a display 488 of the answer to the input text, a text box 490 for further inputting an input text, and a send button 492. The display 486 of the selection indicates that the related term “OCR” 487a is selected and the related term “MIF” 487b is not selected by grayed-out display. The display 488 of the answer includes the answer text generated using the related term “OCR”. The display 488 of the answer to the input text serves as a user interface component to output the answer in the third embodiment.

In the third embodiment described above, electronic documents are searched by using a related term that the user considers appropriate. This enables an electronic document including a technical term that is not included in the input text but is semantically related to the input text to be searched for with a higher accuracy. This can thus increase the accuracy of the answer generated by the generative model 270. The related term is selected before the prompt text is output to the generative model 270. This reduces generally costly inquiries to the generative model 270. This can thus reduce resource consumption due to execution of inference by the generative model 270 and network communication for the inquiries.

In the third embodiment described above, the user selects the designation button 477 corresponding to a related term that the user desires to use. Thus, the related term to be used in document search is designated positively. However, as in the second embodiment, the related term used in document search may be negatively selected by designation of a related term to be removed.

Processes performed by a web browser running on the client terminal 110 in the above-described embodiments will be described in detail below. The web browser may be a browser application or an application using a web view function. The web view is a mechanism or component for displaying a web page in a native application. The web view can display web content (Hypertext Markup Language (HTML)/Cascading Style Sheets (CSS)/JavaScript®) as a part of an application screen without opening a web browser.

The web browser includes a browser engine, a script engine, and a network engine.

The browser engine refers to a function of interpreting a structure (HTML) and a style (CSS) of a web page and displaying the web page on a screen. Functions of the browser engine include HTML parsing to build a Document Object Model (DOM) tree, CSS parsing to apply style rules, layout calculation to determine positions and sizes of elements, painting to execute pixel-level drawing processing (reflection on a UI), and recalculation and redrawing to re-render in accordance with changes in the DOM/CSS.

The network engine refers to a function of acquiring and transmitting resources (such as HTML, CSS, scripts, and images) of a web page using a communication protocol such as Hypertext Transfer Protocol (Secure) (HTTP(S)). Functions of the network engine include generation and transmission of a URL request for requesting a server to perform HTTP methods such as GET and POST, protocol management to perform communication in a procedure according to a protocol such as HTTP/HTTPS or Hypertext Transfer Protocol version 2 (HTTP/2), response reception to acquire a response such as an HTML document, an image, or JavaScript® Object Notation (JSON), cache control to manage reuse of the same resource, and security handling including Transport Layer Security (TLS) communication and certificate checking.

The script engine is an execution engine for interpreting and executing JavaScript®, and is a function responsible for dynamic actions (such as event processing and DOM manipulation) of a web page. Functions of the script engine include parsing and syntax analysis to convert JavaScript® code into an abstract syntax tree (AST), Just-In-Time (JIT) compilation to perform conversion into bytecode and execute the bytecode for speedup, execution context management for holding variables, functions, and scopes, garbage collection for memory management and automatic release, and cooperation with the DOM.

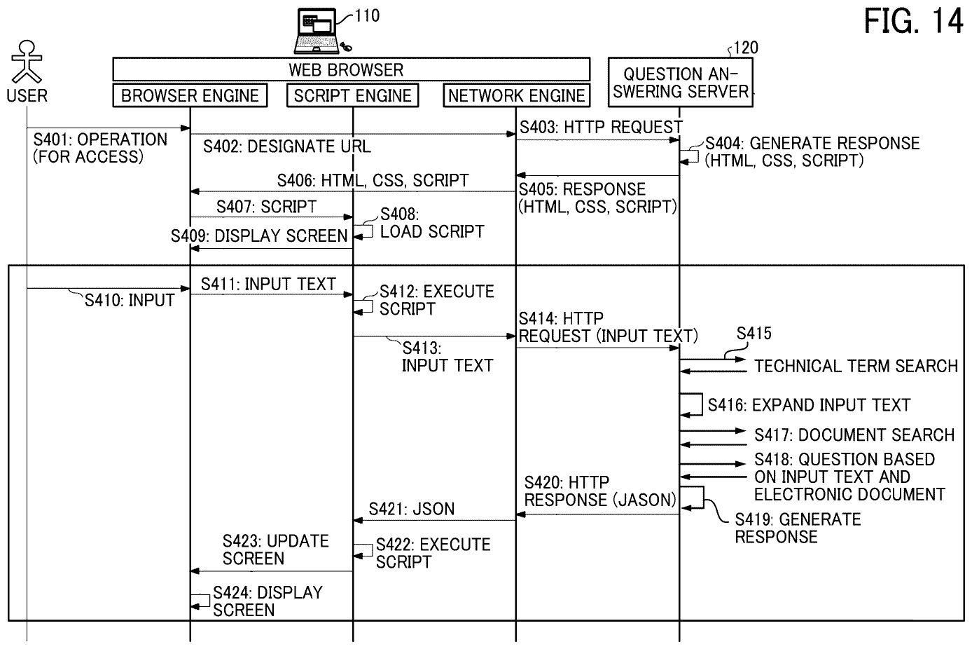

FIG. 14 is a sequence diagram illustrating a process performed by the question answering system 100 to cause a web browser to display an answer text on a question screen.

In steps S401 to S409, a procedure of displaying an initial screen on a display will be described. This screen corresponds to, for example, the question screen 400 illustrated in FIGS. 7A, 10A, and 13A. In step S401, a user inputs, to the client terminal 110, an operation for accessing the question answering server 120. The input unit 212 of the client terminal 110 receives the operation.

In response to this operation, the browser engine of the web browser notifies the network engine of a URL of the question answering server 120 in step S402. In step S403, the network engine generates and transmits an HTTP request addressed to the URL. An HTTP request using a so-called GET method means a request for updating the entire screen.

In step S404, the transmission/reception unit 221 of the question answering server 120 receives the HTTP request, and the answer returning unit 232 generates a response message as described in the above embodiments. Since the request is a normal HTTP request, the display control unit 238 determines to return information for the entire screen. The display control unit 238 generates an HTTP response. The content of the HTTP response is display data for displaying a screen including the response message. The HTTP response includes HTML, CSS, and scripts, for example.

In step S405, the transmission/reception unit 221 of the question answering server 120 transmits the HTTP response to the client terminal 110. In step S406, the network engine receives the HTTP response and notifies the browser engine of the HTTP response. In step S407, the browser engine provides scripts written in the HTTP response to the script engine. In step S408, the script engine loads the scripts to the memory. In step S409, the script engine executes the scripts to generate content, and provides the content to the browser engine. The browser engine displays a screen by placing the content generated by the script engine on a screen generated by analyzing the HTML and the CSS. Since the HTML includes “<html> . . . </html>”, the browser engine discards a current DOM, and parses new HTML, and redraws the screen.

As described above, in the initial screen display, the web browser displays a screen using all of the HTML, the CSS, and the scripts (for example, FIG. 7A, FIG. 10A, and FIG. 13A).

In steps S410 to S424, a procedure of updating the screen displayed on the display to display a message and an image on the screen will be described. This screen corresponds to, for example, the screens illustrated in FIGS. 7B and 7C, FIGS. 10B and 10C, and FIGS. 13B and 13C.

In step S410, the user inputs an input text to the client terminal 110.

The input unit 212 acquires the input text. In step S411, the browser engine notifies the script engine of the input text. In step S412, the script engine executes processing written in the scripts for a case where an input text is input. When an input text is received, the script engine includes “/api/” in a URL of a destination of an HTTP request. Including “/api/” in the URL generally indicates a request for only data in a web server. A path including “/api/” is a route for returning data for programs, rather than HTML for updating the screen. Thus, the question answering server 120 returns only the data in a format such as JSON or extensible Markup Language (XML). The script engine determines to include the input text after “/api/” and to transmit the input text.

In step S413, the script engine notifies the network engine of the input text. In step S414, the network engine includes the input text in the URL of the destination of the HTTP request and transmits the HTTP request to the question answering server 120 that is the destination.

In response to the transmission/reception unit 221 of the question answering server 120 receiving the HTTP request, the technical term identification unit 224 performs vector search (i.e., technical term search) on the technical term dictionary 240 using the input text and acquires a related term as a result of the vector search in step S415 as in the above embodiments. In step S416, the input text expanding unit 226 of the question answering server 120 adds the related term to the input text to generate an expanded input text. In step S417, the document search unit 228 of the question answering server 120 performs vector search (i.e., document search) on the electronic document database 260 using the expanded input text, and acquires the related document as a result of the vector search. In step S418, the prompt output unit 230 of the question answering server 120 transmits a prompt text using the input text and the related document to the generative model 270, and acquires an answer text from the generative model 270.

In step S419, the answer returning unit 232 of the question answering server 120 uses the answer text from the generative model 270 to return (output) an answer to the client terminal 110. Since the input text is received together with “/api/”, the display control unit 238 of the question answering server 120 includes only a difference from the current screen in the JSON. In the present embodiments, the JSON includes a response message. In step S420, the display control unit 238 generates an HTTP response including the JSON. The transmission/reception unit 221 of the question answering server 120 transmits the HTTP response to the client terminal 110.

In step S421, the network engine receives the HTTP response and notifies the script engine of the HTTP response. In step S422, the script engine executes processing written in the scripts for a case where display data is received. The script engine analyzes, for example, “document.getElementById(“chat-area”).innerHTML=renderMessages(data)” and determines to additionally display the response message (i.e., answer text). In step S423, the script engine sends the JSON to the browser engine to request the browser engine to update the screen. In step S424, the browser engine displays the response message included in the JSON on the question screen to update the question screen. Thus, the client terminal 110 can newly display only an updated portion instead of re-displaying the entire web page. In addition, a single-page application can load faster.

In the above-described embodiments, the display control unit 238 returns an answer in a predetermined data format (e.g., JSON) as a difference from the current screen. This allows the client terminal 110 to update the screen based on the answer in the predetermined data format (e.g., JSON) in response to receipt of the answer. Thus, the question answering server 120 can reduce a processing load of displaying the answer on the question screen, and can shorten time for display.

In the description above, a mode (referred to as a so-called chat mode or interactive mode) has been described in which an input text is input via a question screen and an answer text is displayed on the question screen each time. However, an electronic document can be used which is retrieved by applying the above-described technique while more autonomously executing a plurality of processes continuously. Examples of a mechanism for autonomously executing a plurality of processes continuously include an artificial intelligence (AI) agent. The AI agent is a system that autonomously makes decisions and plans and executes tasks in order to achieve a goal. Examples of the mechanism for autonomously executing a plurality of processes continuously also include agentic AI. The agentic AI is more comprehensive than an AI agent and is more advanced and more autonomous, and can also be used.

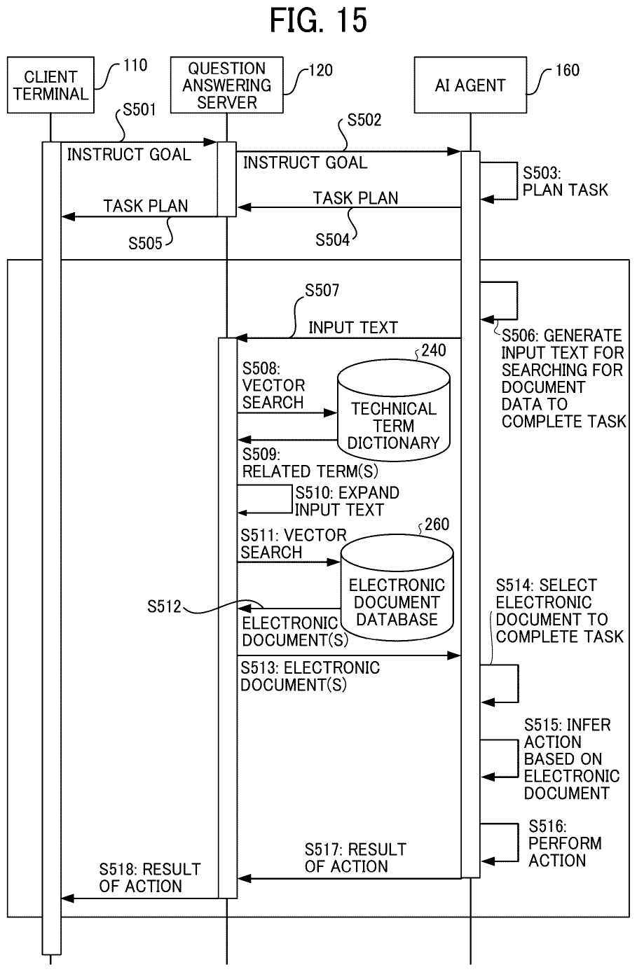

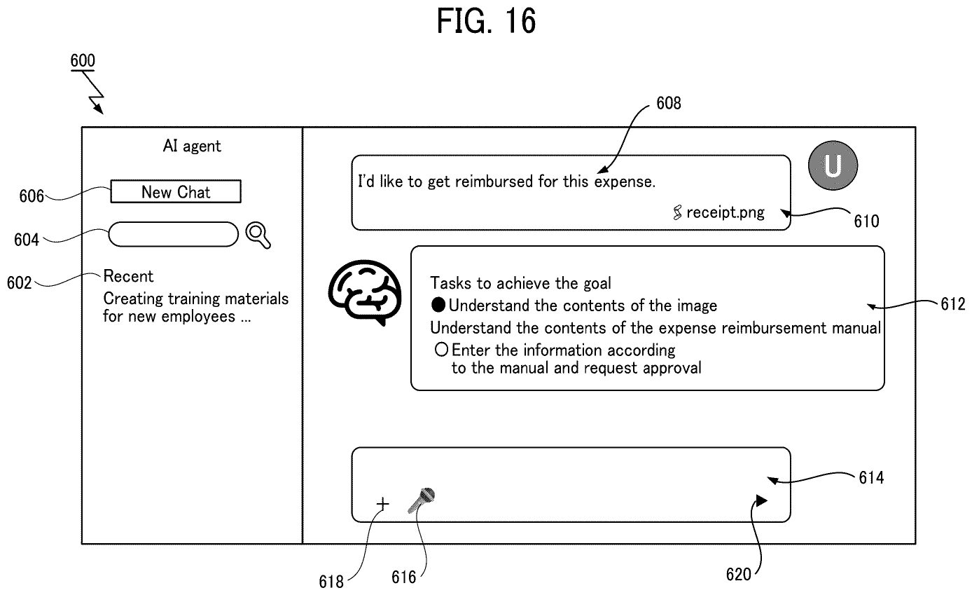

A fourth embodiment that uses the AI agent will be described with reference to FIGS. 15 and 16. FIG. 15 is a sequence diagram illustrating a process performed by the question answering system 100 according to the fourth embodiment from receiving of a question to outputting of a response.

In response to a user inputting a goal instruction via a question screen on the client terminal 110, the process illustrated in FIG. 15 starts from step S501, in which the client terminal 110 transmits the goal instruction input by the user to the question answering server 120. In step S502, the question answering server 120 further transmits the goal instruction to an AI agent 160. In step S503, the AI agent 160 creates a task plan to achieve the goal. In step S504, the AI agent 160 transmits the created task plan to the question answering server 120.

In step S506, the AI agent 160 generates an input text for collecting electronic data used to complete the task. In step S507, the AI agent 160 transmits the input text to the question answering server 120.

In step S508, the technical term identification unit 224 of the question answering server 120 performs vector search on the technical term dictionary 240 using the input text. In step S509, the question answering server 120 acquires a result of the vector search, i.e., a related term. In step S510, the input text expanding unit 226 of the question answering server 120 adds the related term to the input text to generate an expanded input text. In step S511, the document search unit 228 of the question answering server 120 performs vector search on the electronic document database 260 using the expanded input text. In step S512, the question answering server 120 acquires a result of the vector search, i.e., one or more related documents.

In step S513, the prompt output unit 230 of the question answering server 120 transmits at least the one or more related documents to the AI agent 160. When multiple electronic documents are found as the search result, the multiple electronic documents are transmitted. In step S514, the AI agent 160 selects an electronic document for completing the task. In step S515, the AI agent 160 infers an action to be performed, based on the selected electronic document. In step S516, the AI agent 160 performs the inferred action. In step S517, the question answering server 120 acquires a result of the action from the AI agent 160. At that time, the action is performed using software or an API as desired. The action may be, for example, an operation on a robot. In step S518, the answer returning unit 232 of the question answering server 120 uses the answer text from the AI agent 160 to return the result of the action as an answer to the client terminal 110. This step may be skipped if output of the result of the action is not desired. The result of the action to be output may include, for example, a created document or information indicating the completion.

Processing from generation of the input text in step S506 to outputting of the result of the action in step S518 may be repeated as desired (or for each task). The processing from steps S507 to S514 may be omitted when the task can be completed without collection of electronic data.

FIG. 16 illustrates a screen 600 displayed by the question answering system 100 according to the fourth embodiment of the present disclosure. The screen 600 illustrated in FIG. 16 presents communication with an AI agent and displays a history 602 of communication to date in a left portion thereof. The history 602 may be displayed in several groups such as recent, a predetermined date, and a date range. Above the history 602, there is a search field 604 for searching chat history. By inputting a desired search word into the search field 604, chat history including the word can be obtained as a search result. Above the search field 604, there is a button 606 for starting new communication. The screen 600 displays a goal 608 input by a user in an upper central portion thereof. In this example, an attached file 610 is also included.

The screen 600 displays a task plan 612 output from the AI agent in a central portion thereof.

The task plan 612 displays planned tasks. The tasks are displayed differently according to the status thereof such that a black circle indicates a task that has already been completed, three dots indicate a task that is in execution, and a white circle indicates a task waiting to be executed (yet to be executed). Thus, a user can easily grasp which task has been completed, which task is currently in execution, and which task is yet to be executed.

The screen 600 displays an input field 614 for inputting a goal (i.e., instruction text) in a lower central portion thereof. In the input field 614, the user can input an input text that is a natural-language text. The input field 614 may include a button 616 for voice input and a button 618 for attaching a file. In response to pressing of a send button 620, the goal input by the user is transmitted to the question answering server 120.

According to the fourth embodiment described above, an electronic document can be searched for with high accuracy in response to an input text generated by the AI agent 160. This can thus increase the accuracy of goal achievement (or task completion) by the AI agent 160.

In the technique of the related art, in order to handle a specific term such as a technical term, data search is performed for documents using an explanatory text, a synonym, an associated keyword of the term with a term dictionary, for example. Although an explanatory text can be added for a term such as a technical term at a word level, it is difficult to identify a term from a text expression conversely. Therefore, the technique of the related art is insufficient in that while a user who knows a specific term can search for data such as documents in which the specific term is not used, it is difficult for a user who does not know the specific term to search for data such as documents in which the specific term is used.

The technique of the related art enables the retrieval of a document including content that is associable from a search text and that is presumed to be desired by a searcher, for example. For example, a keyword extracting unit extracts keywords from a search text input by a user using a morphological analysis dictionary and a synonym dictionary, acquires associated keywords associated with a set of search keywords from a knowledge dictionary, and searches for a document from a logical expression obtained by combining the acquired associated keywords. However, the search keywords extracted from the search text are to be directly associated in the knowledge dictionary, and a specific term is not identifiable from an expression that is not directly included in the knowledge dictionary. That is, the technique of the related art is insufficient in that a user who does not know a specific term cannot search for data such as documents in which the specific term is used.

In view of the foregoing, the one or more embodiments described above provide an information processing system, an information processing apparatus, an information processing method, and a program that enable retrieval of an electronic document based on a term associated in advance with a text similar to an input text. The one or more embodiments described above also increase the answer accuracy when the answer is generated using the retrieved electronic document.

In the description above, an input text is input via a question screen displayed on the display unit 214 of the client terminal 110 and an answer text is displayed on the question screen. However, interaction with a user is not limited to such interaction via a graphical user interface. For example, a mode is also conceivable in which the input text 300 is input by voice input using speech recognition (speech-to-text conversion) and the answer text is output by voice using speech synthesis (text-to-speech conversion). In such a case, the user interface component to accept input of an input text, the second user interface component to output an answer, and the user interface component to output one or more related terms in a selectable manner are voice input/output interfaces instead of the graphical user interfaces.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The functions described above can be implemented as a computer-executable program written in a legacy or object-oriented programming language such as assembler, C, C++, C#, or Java®. The computer-executable program can be distributed through a telecommunication line or can be stored and distributed on a device-readable recording medium such as a ROM, an electrically erasable programmable read-only memory (EEPROM), an erasable programmable read-only memory (EPROM), a flash memory, a flexible disk, a compact disc read-only memory (CD-ROM), a compact disc rewritable (CD-RW), a digital versatile disc read-only memory (DVD-ROM), a digital versatile disc random access memory (DVD-RAM), a digital versatile disc rewritable (DVD-RW), a Blu-ray disc, a secure digital (SD) card, or a magneto-optical (MO) disk.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

Aspects of the present disclosure are, for example, as follows.
According to Aspect 1, an information processing system includes a storage unit, an accepting unit, an identification unit, a search unit, and a response unit. The storage unit stores terms and corresponding texts in association with each other. The corresponding texts each correspond to a respective one of the terms. The accepting unit receives input of an input text. The identification unit identifies a term associated with a corresponding text that is similar to the input text among the corresponding texts, based on similarities between the input text and the corresponding texts. The search unit searches for electronic data, based on the identified term. The response unit outputs a response based on the electronic data retrieved in the search.
According to Aspect 2, the information processing system of Aspect 1 further includes an output unit. The output unit outputs an output text to a generative model, based on the input text and the electronic data retrieved in the search. The response unit returns, as the response, an answer to the input text, based on an answer text obtained from the generative model for the output text.
According to Aspect 3, the information processing system of Aspect 2 further includes a control unit. The control unit controls an information terminal to output a first user interface component to receive the input of the input text, and a second user interface component to output the answer.
According to Aspect 4, in the information processing system of Aspect 3, the response unit returns the answer in a predetermined data format as a difference from a screen currently displayed on the information terminal, and the control unit controls the information terminal to update the screen, based on the answer in the predetermined data format in response to receipt of the answer.
According to Aspect 5, in the information processing system of any one of Aspects 2 to 4, the answer includes the answer text and one or more identified terms including the identified term. The information processing system further includes a selection unit. The selection unit receives selection of at least one term from among the one or more identified terms. The output unit outputs another output text to the generative model, based on other electronic data retrieved in a re-search performed by the search unit using the at least one selected term. The response unit returns another answer, based on another answer text obtained for the other output text from the generative model.
According to Aspect 6, the information processing system of Aspect 5 further includes a control unit. The control unit controls an information terminal to output a first user interface component to receive the input of the input text, a second user interface component to output the answer text and output the one or more identified terms in a selectable manner, and a third user interface component to output the other answer.
According to Aspect 7, the information processing system of any one of Aspects 2 to 6 further includes a proposing unit and a selection unit. The proposing unit proposes one or more identified terms including the identified term. The selection unit receives selection of at least one term from among the one or more proposed identified terms. The at least one selected term is used to search for the electronic data.
According to Aspect 8, the information processing system of Aspect 7 further includes a control unit. The control unit controls an information terminal to output a first user interface component to receive the input of the input text, a second user interface component to output the one or more identified terms in a selectable manner, and a third user interface component to output the answer.
According to Aspect 9, in the information processing system of any one of Aspects 1 to 8, the identification unit identifies the term associated with the corresponding text that is similar to the input text, based on vector similarities between an input text vector and corresponding text vectors. The input text vector is converted from the input text using an embedding model. The corresponding text vectors are converted from the respective corresponding texts stored in the storage unit using the embedding model.
According to Aspect 10, in the information processing system of Aspect 9, the search unit searches for the electronic data, based on vector similarities between an expanded input text vector and document vectors. The expanded input text vector is converted from an expanded input text using the embedding model. The expanded input text is obtained by adding the identified term to the input text. The document vectors are converted from respective electronic data sets using the embedding model. The electronic data sets are stored externally or internally.
According to Aspect 11, the information processing system of any one of Aspects 1 to 10 further includes an agent that outputs the input text for a planned task to the accepting unit in response to a goal input by a user. The agent infers an action, based on the electronic data acquired as the response to the input text.
According to Aspect 12, an information processing apparatus includes a storage unit, an accepting unit, an identification unit, a search unit, and a response unit. The storage unit stores terms and corresponding texts in association with each other. The corresponding texts each correspond to a respective one of the terms. The accepting unit receives input of an input text. The identification unit identifies a term associated with a corresponding text that is similar to the input text among the corresponding texts, based on similarities between the input text and the corresponding texts. The search unit searches for electronic data, based on the identified term. The response unit outputs a response based on the electronic data retrieved in the search.
According to Aspect 13, the information processing apparatus of Aspect 12 further includes an output unit. The output unit outputs an output text to a generative model, based on the input text and the electronic data retrieved in the search. The response unit returns, as the response, an answer to the input text, based on an answer text obtained for the output text from the generative model.
According to Aspect 14, an information processing method includes: by a computer, receiving input of an input text; in a storage unit that stores terms and corresponding texts in association with each other, the corresponding texts each corresponding to a respective one of the terms, identifying a term associated with a corresponding text that is similar to the input text among the corresponding texts, based on similarities between the input text and the corresponding texts; searching for electronic data, based on the identified term; and outputting a response based on the electronic data retrieved in the searching.
According to Aspect 15, the information processing method of Aspect 14 further includes: outputting an output text to a generative model, based on the input text and the electronic data retrieved in the searching. The outputting of the response includes returning, as the response, an answer to the input text, based on an answer text obtained for the output text from the generative model.
According to Aspect 16, a program causes a computer to function as a storage unit, an accepting unit, an identification unit, a search unit, and a response unit. The storage unit stores terms and corresponding texts in association with each other. The corresponding texts each correspond to a respective one of the terms. The accepting unit receives input of an input text. The identification unit identifies a term associated with a corresponding text that is similar to the input text among the corresponding texts, based on similarities between the input text and the corresponding texts. The search unit searches for electronic data, based on the identified term. The response unit outputs a response based on the electronic data retrieved in the search.
According to Aspect 17, the program of Aspect 16 further causes the computer to function as an output unit. The output unit outputs an output text to a generative model, based on the input text and the electronic data retrieved in the search. The response unit returns, as the response, an answer to the input text, based on an answer text obtained for the output text from the generative model.

1. An information processing system comprising:
a memory that stores terms and corresponding texts in association with each other, the corresponding texts each corresponding to a respective one of the terms; and
circuitry configured to:
receive input of an input text;
identify a term associated with a corresponding text that is similar to the input text among the corresponding texts, based on similarities between the input text and the corresponding texts;
search for electronic data, based on the identified term; and
output a response based on the electronic data retrieved in the search.

2. The information processing system according to claim 1, wherein the circuitry is configured to:
output an output text to a generative model, based on the input text and the electronic data retrieved in the search; and
return, as the response, an answer to the input text, based on an answer text obtained from the generative model for the output text.

3. The information processing system according to claim 2, wherein the circuitry is configured to cause an information terminal to output:
a first user interface component to receive the input of the input text; and
a second user interface component to output the answer.

4. The information processing system according to claim 3, wherein the circuitry is configured to return the answer in a predetermined data format as a difference from a screen currently displayed on the information terminal, to cause the information terminal to update the screen, based on the answer in the predetermined data format in response to receipt of the answer.

5. The information processing system according to claim 2, wherein
the answer includes the answer text and one or more identified terms including the identified term, and
the circuitry is configured to:
receive selection of at least one term from among the one or more identified terms;
output another output text to the generative model, based on other electronic data retrieved in a re-search performed using the at least one selected term; and
return another answer, based on another answer text obtained for said another output text from the generative model.

6. The information processing system according to claim 5, wherein the circuitry is configured to cause an information terminal to output:
a first user interface component to receive the input of the input text;
a second user interface component to output the answer text and output the one or more identified terms for selection; and
a third user interface component to output said another answer.

7. The information processing system according to claim 2, wherein the circuitry is configured to:
propose one or more identified terms including the identified term;
receive selection of at least one term from among the one or more proposed identified terms; and
use the at least one selected term to search for the electronic data.

8. The information processing system according to claim 7, wherein the circuitry is configured to cause an information terminal to output:
a first user interface component to receive the input of the input text;
a second user interface component to output the one or more identified terms for selection; and
a third user interface component to output the answer.

9. The information processing system according to claim 1, wherein the similarities include vector similarities between an input text vector and corresponding text vectors, the input text vector being converted from the input text using an embedding model, the corresponding text vectors being converted from the respective corresponding texts stored in the memory using the embedding model.

10. The information processing system according to claim 9, wherein the circuitry is configured to search for the electronic data, based on vector similarities between an expanded input text vector and document vectors, the expanded input text vector being converted from an expanded input text using the embedding model, the expanded input text being obtained by adding the identified term to the input text, the document vectors being converted from respective electronic data sets using the embedding model, the electronic data sets being stored externally or internally.

11. The information processing system according to claim 1, wherein the circuitry is configured to
activate an agent that outputs the input text for a planned task in response to a goal input by a user, wherein
the agent infers an action, based on the electronic data acquired as the response to the input text.

12. An information processing method comprising:
receiving input of an input text;
referring to a memory that stores terms and corresponding texts in association with each other, the corresponding texts each corresponding to a respective one of the terms, identifying a term associated with a corresponding text that is similar to the input text among the corresponding texts, based on similarities between the input text and the corresponding texts;
searching for electronic data, based on the identified term; and
outputting a response based on the electronic data retrieved in the searching.

13. The information processing method according to claim 12, further comprising:
outputting an output text to a generative model, based on the input text and the electronic data retrieved in the searching, wherein
the outputting the response includes returning, as the response, an answer to the input text, based on an answer text obtained for the output text from the generative model.

14. A non-transitory recording medium storing a plurality of instructions which, when executed by one or more processors, causes the processors to perform an information processing method comprising:
receiving input of an input text;
referring to a memory that stores terms and corresponding texts in association with each other, the corresponding texts each corresponding to a respective one of the terms, identifying a term associated with a corresponding text that is similar to the input text among the corresponding texts, based on similarities between the input text and the corresponding texts;
searching for electronic data, based on the identified term; and
outputting a response based on the electronic data retrieved in the searching.

15. The non-transitory recording medium according to claim 14, wherein the information processing method further comprises:
outputting an output text to a generative model, based on the input text and the electronic data retrieved in the searching, wherein
the outputting the response includes returning, as the response, an answer to the input text, based on an answer text obtained for the output text from the generative model.
